(19) United States
(12) Patent Application Publication
(10) Pub. No.: US 2010/0050884 A1
(43) Pub. Date: Mar. 4, 2010

(54) GRILLING PLATE

(75) Inventors: Juergen Leikam, Hilpoltstein (DE); Alwin Neukamm, Wilhermsdorf (DE); Fabian Gauss, Feuchtwangen (DE); Dieter Foerster, Schillingsfurst (DE)

Correspondence Address: Workman Nydegger;1000 Eagle Gate Tower, 60 East South Temple, Salt Lake City, UT, 84111, US

(73) Assignee: ELECTROLUX HOME PRODUCTS CORPORATION N.V., Zaventem (BE)

(21) Appl. No.: 12/523,205

(22) PCT Filed: Jan. 11, 2008
(86) PCT No.: PCT/EP08/00192

§ 371 Date: Sep. 18, 2009

(30) Foreign Application Priority Data
Jan. 19, 2007 (EP) 07001153.1

(51) Int. Cl. A47J 37/00

(52) U.S. Cl. 99/422

(57) ABSTRACT

The invention relates to a grilling plate, which is divided into different sections, wherein at least a part of the sections is connected to a heating element. To better maintain different temperatures in different sections, the invention is characterized in that the grilling plate comprises a plate forming the top side of it and extending uniformly along all sections, wherein the sections are divided by at least one groove being arranged in the bottom side of the plate.

The invention relates to a grilling plate, which is divided into different sections, wherein at least a part of the sections is provided with or connected to a corresponding or associated heating element.

Grilling plates of this kind are well known in the art. Dishes can be cooked by placing them on the upper surface of the grilling plate. Therefore a number of heating elements are arranged underneath the grilling plate, dividing it into different grilling areas or grilling sections.

Sometimes, a sandwich structure is used as basic plate of the grilling plate, wherein a good conductive middle layer from aluminum is arranged between a top layer and a bottom layer made of stainless steel. Advantageously, the grilling plate obtains an evenly distributed temperature which facilitates the grilling or cooking process.

On the other hand, it is not always necessary to use the whole surface of the grilling plate for grilling dishes. In the case that only a part of the grilling plate is necessary it is disadvantageously that the temperature is uniformly distributed along the entire area of the grilling plate. Areas, which should remain cold are heated up undesirably.

As far as only a part of the grilling plate is heated up and no complete temperature equalization occurs thermal tensions can come into being which are also detrimental.

Therefore, it is an object of the invention to provide a grilling plate according to the kind mentioned above which at least partially overcomes the discussed disadvantages. The solution of this object according to the invention is characterized in that the grilling plate comprises a plate or plate body at the or forming the top side of it (or: a top plate or top plate body) and extending uniformly or continuously (or: as a uniform or continuous or single body) along all sections of the grilling plate, wherein the sections are divided by at least one groove being arranged in the bottom side of the plate.

The grooves in the bottom side of the top plate or top plate body make sure that only a minor heat transfer can occur from one section to another. The grilling plate therefore, due to this thermal insulating effect, heats up basically only a desired section or desired sections of it. Also thermal tensions are greatly reduced or practically eliminated compared to grilling plates according to the prior art of homogeneous thickness.

The production of the grilling plate can still be easy and inexpensive. In particular the groove(s) can be machined, in particular by milling, into the bottom surface of the top plate.

According to a first embodiment of the invention the top plate or top plate body consists of at least one layer. In this case the mentioned groove is in particular machined in a homogeneous plate to create the insulating effect.

Preferably, the top plate or top plate body consists of at least two layers. More specifically, the layers can be made of at least two different materials, especially metals.

Advantageously, the grilling plate can consists of three layers, wherein a top layer and a bottom layer are made of steel, especially stainless steel, and wherein an intermediate or medium layer is made of aluminum or an alloy of aluminum. Also copper or an alloy of copper can be employed as the material for the intermediate or medium layer. Finally, it is possible to use also steel for the medium layer which needs not to be necessarily stainless steel. In this case it is a preferred solution that the at least one groove extends through all layers except the top layer.

One groove can be arranged in the plate or plate body or in the grilling plate to separate the plate or plate body or grilling plate into two sections.

A preferred alternative solution comes up with two grooves in the plate or plate body which are arranged to separate the grilling plate into four sections. In this case the two grooves are preferably arranged in a crosswise manner.

The grooves can extend to the border area (or: edge region, outer region) of the plate or plate body or, in other words, be open at or accessible from outside of the border area in a lateral direction or parallel to the plate or plate body.

Alternatively and advantageously, the at least one groove can extend into the proximity or vicinity of the border area of the top plate or top plate body but keep a defined distance from the border area or, in other words, be closed or not accessible from the outside of the border area in a lateral direction or have (longitudinal) groove ends or walls which lie within the plate or plate body. By this design a sufficient rigidity and stability of the grilling plate is maintained. The distance of the grooves (in the longitudinal direction of the grooves) or of the groove ends from the border area or the plate or plate body is an advantageous embodiment selected from a range between 4 mm and 30 mm, in particular between 4 mm and 8 mm, preferably between 5 mm and 6 mm.

The width of the at least one groove is in general chosen between 1 mm and 30 mm, in particular between 8 mm and 20 mm, preferably between 11 mm and 13 mm. Normally, the grilling plate or its top plate or plate body has a substantial rectangular shape. An alternative embodiment comes up with a substantial rounded shape of the grilling plate or its plate or plate body.

The top surface or grilling surface of the top plate or top plate body which the grilling goods are placed upon is in general a continuous surface extending or stretching over all sections of the grilling plate and usually is a plane surface which can be smooth or can also be provided with ribs or grooves to receive grease etc. at least in some section.

In a preferred embodiment in each section of the grilling plate at least one corresponding or associated heating element is provided for independent or separate heating of the sections and arranged under the plate or plate body, in particular held or pressed against or attached to, in particular glued to, the bottom side of the plate or plate body.

Due to the fact that the grilling plate has more than one section which is separately heatable and which is thermally separated from an adjacent section by the described groove the thermal conductivity from one section to another is reduced. Thus, heat brought into a section remains there and an adjacent section is not heated up undesired. Also thermal tensions in the grilling plate can be reduced as the grooves function as an expansion joint. So, a distortion or bending of the grilling plate is reduced. Beneficially, separate zones with different temperatures can be obtained along the surface of the grilling plate. The energy consumption is also reduced because heat can not flow easily away from a section to another. Consequently, the final desired temperature of a section of the grilling plate is reached earlier. So, it becomes easier to cook or grill different dishes at different individual temperatures on one grilling plate.

In the drawings embodiments of the invention are depicted.

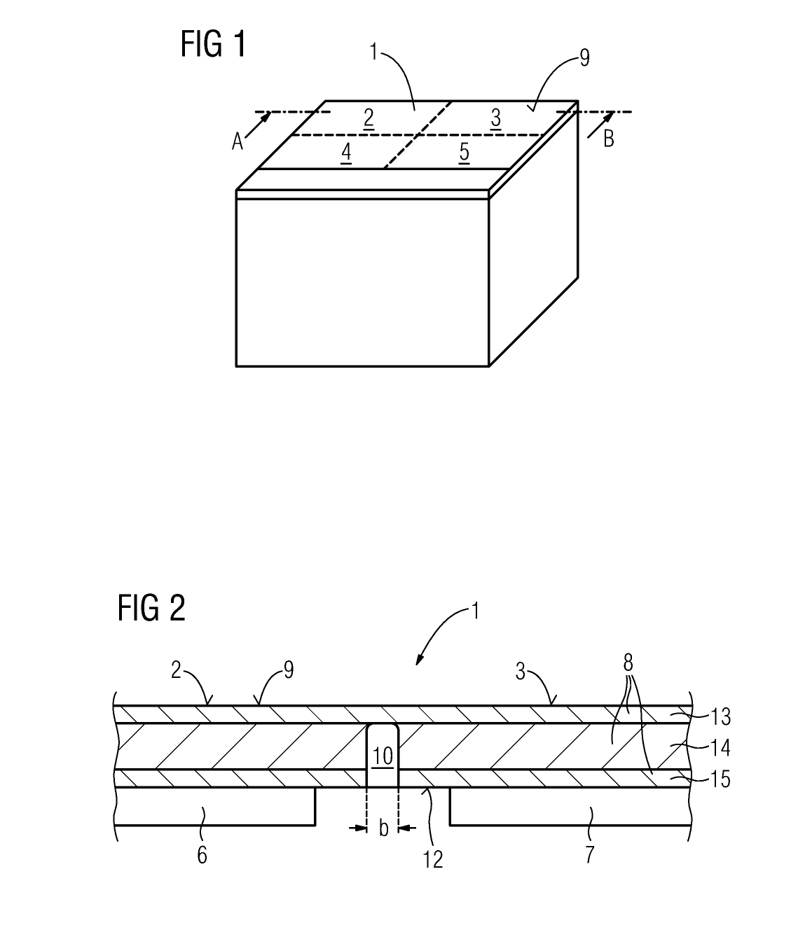

FIG. 1 shows schematically a perspective view of a grilling plate which is arranged on a carrier structure,

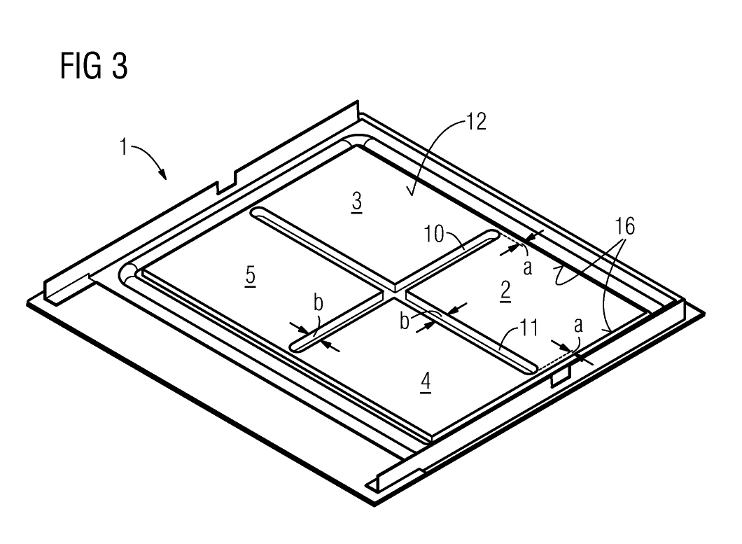

FIG. 2 shows a cross sectional view according to the cut A-B of FIG. 1 showing the cross section through a grilling plate,

FIG. 3 shows the grilling plate according FIG. 1 with its up side down,

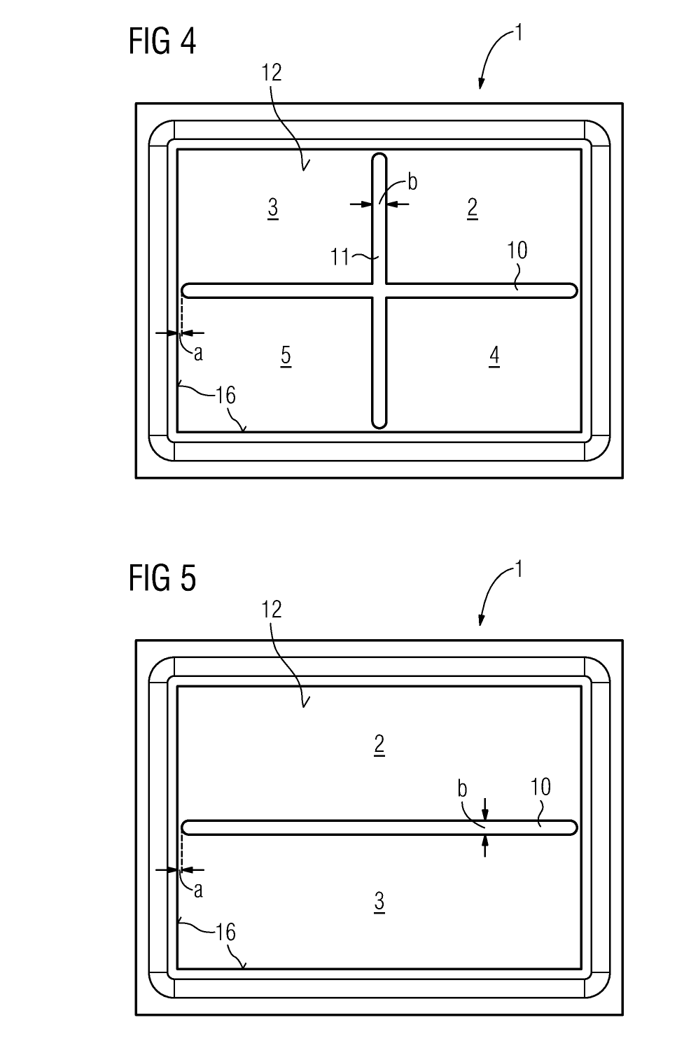

FIG. 4 shows the top plan view on the bottom side of the grilling plate with four grilling sections with its up side down and

FIG. 5 shows the top plan view on the bottom side of the grilling plate with two grilling sections with its up side down.

FIG. 1 shows a grilling plate 1 on a carrier structure. The grilling plate 1 is divided into four sections 2, 3, 4, 5 without the top side or top surface 9 of the grilling plate 1 being interrupted; it consists of a top plate (8, see FIG. 2) which extends continuously along the whole top area of the grilling plate 1.

As can be seen from the schematic drawing according to FIG. 2 (showing the cross section A-B according to FIG. 1) the grilling plate 1 has a top plate or plate body 8. The top plate or plate body 8 consists of three layers 13, 14, 15. The upper and the bottom layer 13, 15 are made of stainless steel. The medium or intermediate layer 14 is made of aluminum. Alternatively, it can also be made e. g. from copper; also normal steel can be used as material for the medium layer 14. The thickness of the intermediate layer 14 in FIG. 1 is larger than the thicknesses of the upper layer 13 and the bottom layer 15.

In general the thickness of the whole top plate or top plate body 8 is typically chosen to be between 8 mm and 20 mm, in particular about 11 mm. The thickness of the intermediate layer 14 is typically between 6 mm and 18 mm, in particular 8.4 mm, and the thicknesses of the upper layer 13 and the bottom layer 15 are typically between 1 mm and 6 mm, typically about 1.3 mm. Underneath each section 2, 3, 4, 5 a separate or corresponding heating element 6, 7 (see FIG. 2) is arranged to individually heat up the associated or corresponding section 2, 3, 4 or 5.

To hinder thermal flow from one section to another, a groove 10 is arranged in the plate or plate body 8 according FIG. 2. The width b of the groove 10 is usually between 1 mm and 30 mm, in particular between 8 mm and 20 mm, preferably between 11 mm and 13 mm.

The mentioned dimensions are an example only. Also, other dimensions can be employed.

As can be seen the groove 10 cuts completely through the bottom layer 15 and the highly conductive medium layer 14, but does not influence the top layer 13 of the plate or plate body 8.

Consequently, the top side 9 of the grilling plate 1 or plate or plate body 8 which the grilling goods are placed upon is not interrupted but homogeneously designed, in case of the FIGs as a planar grilling or top surface, and, instead, the bottom side 12 of the plate or plate body 8 has the interruption or interception by the groove 10.

Different designs of the grilling plate 1 are depicted in FIGS. 3, 4 and 5, where the grilling plate 1 is shown with the up side down.

The solution according to FIGS. 3 and 4 comes up with two crosswise arranged grooves 10 and 11 dividing the plate or plate body 8 and, thus, the grilling plate 1 in four sections 2, 3, 4, 5.

The design according to FIG. 5 shows only two sections 2, 3, which are delimited by the groove 10. In principle, the grooves 10, 11 can extend along the whole width of the plate or plate body 8. It is merely aimed for that the stiffness of the plate or plate body 8 is sufficient.

Preferably, however, the extension of the grooves 10, 11 is limited in all depicted solutions according to the embodiments in the FIGs. Specifically, the grooves 10, 11 remain at a distance a from the border area (or: edge, outer region) 16 of the top plate or top plate body 8 or grilling plate 1. This ensures a high stiffness of the top plate or top plate body 8 and, thus, the grilling plate 1 in spite of the grooves 10, 11. The dimension of the distance a is in general chosen between 4 mm and 30 mm, in particular between 4 mm and 8 mm, preferably between 5 mm and 6 mm, such as 5.5 mm.

While the groove 10 runs transversely across the plate in FIG. 5 it is also a preferred embodiment of the invention that the groove 10 is oriented in a way rotated by 90 [deg.] compared to that one depicted in FIG. 5.

All sections 2, 3, 4, 5 of the grilling plate can be heated individually by respective separate heating elements to a desired individual temperature. Due to the insulation effect of the grooves 10, 11 the heat remains in the respective sections 2, 3, 4, 5. Consequently, a dish can be grilled on one section while the adjacent section remains substantial cold.

The production of the grilling plate 1 is quite easy and thus economical. The grooves can be machined in a cheap way by means of a milling process, in particular a finger mill or end mill milling the groove in the plate or plate body 8.

As only a part of the grilling plate, i. e. the respective wanted section 2, 3, 4, 5, is warmed up the energy consumption of the grilling plate is reduced compared with pre-known solutions. Also the final temperature necessary for cooking a dish is reached quicker as it is the case with conventional grilling plates. Due to the preferred design of the grilling plate with different sections a plurality of different dishes or grilling goods can be grilled with their optimum grilling temperatures because the influence between the different sections is minimized.

The distortion or bending of the grilling plate 1 during warming up is also minimized.

Within a single section 2, 3, 4, 5 the temperature equalization is occurring quite fast as the highly conductive layer 14 from aluminum extends across the whole section.

The thermal expansion of the grilling plate 1 is smaller than in conventional plates as parts of the plate or plate body 8 are removed. The grooves 10, 11 between two sections 2, 3, 4, 5 function as expansion joints.

### REFERENCE NUMERALS

1 Grilling plate

2 Section 3 Section

4 Section

5 Section

6 Heating element

7 Heating element 8 Plate body

9 Top side

10 Groove

11 Groove

12 Bottom side 13 Layer

14 Layer

15 Layer

16 Border area

a Distance b Width

1-15. (canceled)

16. Grilling plate, which is divided into different sections:
wherein at least a part of the sections is connected to or provided with a corresponding or associated heating element;
wherein the grilling plate comprises a plate or plate body at the or forming the top side of the grilling plate and extending uniformly or continuously along all sections;
wherein the sections are divided by at least one groove being arranged in the bottom side of the plate or plate body; and
wherein the at least one groove extends into the proximity of a border area of the plate or plate body keeping a defined distance from the border area

17. Grilling plate according to claim 16, wherein the distance of the at least one groove from the border area is selected from a range between 4 mm and 30 mm, in particular between 4 mm and 8 mm, preferably between 5 mm and 6 mm.

18. Grilling plate according to claim 16, wherein the plate or plate body consists of at least one layer.

19. Grilling plate according to claim 16, wherein the plate or plate body consists of at least two layers.

20. Grilling plate according to claim 19, wherein the layers are made of at least two different materials, in particular of at least two different metals.

21. Grilling plate according to claim 18:
wherein the plate or plate body consists of three layers;
wherein a top layer and a bottom layer are made of steel, especially stainless steel; and
wherein an intermediate layer is made of aluminum or an alloy thereof or copper or an alloy thereof.

22. Grilling plate according to claim 18, wherein the at least one groove extends through all layers except the top layer.

23. Grilling plate according to claim 16, wherein one groove is arranged in the plate or plate body to separate the grilling plate into two sections.

24. Grilling plate according to claim 16, wherein two grooves are arranged in the plate or plate body to separate the grilling plate into four sections.

25. Grilling plate according to claim 24, wherein the two grooves are arranged in a crosswise manner.

26. Grilling plate according to claim 16, wherein the width of the at least one groove is between 1 mm and 30 mm, in particular between 8 mm and 20 mm, preferably between 10 mm and 14 mm.

27. Grilling plate according to claim 16, wherein the grilling plate has a substantial rectangular shape or a substantial rounded shape.

28. Grilling plate according to claim 16, wherein, in each section, at least one corresponding or associated heating element is provided and arranged under the plate or plate body, in particular held or pressed against or attached to, in particular glued to, the bottom side of the plate or plate body.

29. Grilling plate according to claim 16, wherein the top surface or grilling surface of the plate or top plate is a continuous surface extending over all sections of the grilling plate and/or is a plane surface.
